(19) United States
(12) Patent Application Publication
(10) Pub. No.: US 2013/0015079 A1
(43) Pub. Date: Jan. 17, 2013

(54) MULTI-MEDIA BOOK, PHOTO ALBUM, CATALOG AND JEWELRY BOX

(71) Applicant: Allen Arzoumanian, Cerritos, CA (US)

(72) Inventor: Allen Arzoumanian, Cerritos, CA (US)

(21) Appl. No.: 13/180,788

(22) Filed: Jul. 12, 2011

(51) Int. Cl. A45C 11/16; H04N 7/18

(52) U.S. Cl. 206/6.1; 348/61; 348/E07.085

(57) ABSTRACT

The present invention relates to a multi-media system of books, photo albums, catalogs, and jewelry boxes that are capable of playing video and audio content. A multi-media system according to the present invention comprises a first member that is capable of opening and closing in relation to a second member in a clam-like or book-like manner. The opening and closing movements of the members are detected by a sensor that activates a media device for playing video and audio content.

### FIELD OF THE INVENTION

The present invention relates to electronic books, photo albums, catalogs, and jewelry boxes. More specifically, the present invention relates to books, photo albums, catalogs, and jewelry boxes that are capable of playing video and audio content.

### BACKGROUND OF THE INVENTION

With recent advancements in multi-media technologies, the experience of reading a book, looking at pictures in a photo album, or perusing a catalog stands to be transformed by the ability to synchronize video and audio content with the turning of the page. For example, the written text of a book can be enhanced by adding spoken narrative, music, sound effect or video that is programmed to change with each page, so that the tactile aspect of reading by physically turning pages is enhanced by the added content. Similarly, the pictures of a photo album can be brought to life with video and audio that is played when a picture is viewed. And even commercial catalogs can be revolutionized by incorporating virtual content and enabling consumers to purchase goods directly from the catalogs. Not only can video and audio content be added to books, photo albums, catalogs and the like, the addition of content can also be used to enhance jewelry boxes as well, such that special content is associated with the experience of opening and closing a jewelry box.

The present invention is directed to books having multi-media content. There are electronic books that are stored and read on tablet devices, but such devices do not permit the tactile experience associated with reading a traditional book, such as the ability to flip physical pages back and forth. While there are also reader books that employ optical pens to scan built-in electronic codes that play audio, these books require special equipment and they do not have the ability to display video.

Another application of the present technology is to photo albums. A photo album is more than just a collection of photographs in a book; it is the narrative of our individual and collective stories, the chronicling of our most precious memories. Photo albums have had a long history in our culture. They first became popular with the arrival of calling cards, small photographs produced by professional studios in the mid nineteenth century. Photo albums became increasingly popular as technological advances made photography common and ubiquitous. As more and more people took more and more pictures, photo albums became important repositories of lives. In this regard, the size and function of photo albums have changed with the evolution in technology.

However, the traditional photo album can no longer keep pace with the recent revolution in camera technology. The utility of digital cameras, which makes it possible to take hundreds of pictures at a time, has engendered a need to store and display mass collections of pictures in a way that is both aesthetic and accessible. It has become inconvenient and impractical to store mass collections of pictures in traditional photo albums.

Furthermore, traditional photo albums are antiquated and limited in that they only present pictures, without the accompaniment of moving images, sound or music to enhance the viewing experience. The story that a picture tells could be enhanced in an infinite variety of ways by adding music or spoken narrative, which is possible with new digital audio technology. As with the revolution in photography, the revolution in digital music, for example, has made it possible to collect large compilations of songs in a compact format. This makes it possible to apply music or other digitally recorded sounds to photo albums to enhance the experience of perusing pictures in a photo album.

Attempts have been made to apply digital technology to photo albums. While digital albums are known, such devices are typically comprised of little more than an electronic device for storing digital photographs. These devices do not provide the tactile experience associated with leafing through the pages of an album, in which the turn of each page adds to the telling of an album's story.

For example, U.S. Pat. No. 7,411,578 teaches a digital photo album comprising of a “box structure with an external appearance of a photo album” with a screen for displaying images. The device is an album in appearance only. It does not have the physical structure of a traditional photo album with pages that turn. Thus, it does function like a traditional album in that the presentation of images is divorced from the physical experience of flipping the pages of an album back and forth. Moreover, the album does not permit music or sound to be played with the pictures.

The present invention is also directed to sales catalogs and the like. While online shopping has exploded in recent years, with millions of online retail transactions conducted yearly, traditional catalogs remain an important marketing device for consumer businesses. Countless thousands of catalogs are mailed each year at tremendous economic and environmental costs. It is becoming unsustainably costly to print and mail catalogs. Moreover, catalogs are often ineffective because the marketing is not directly connected to the online transaction process. The present invention is directed to an electronic catalog that can be automatically updated, so as to reduce economic and environmental costs. The catalog can be electronically linked to the Internet so that the consumer can conduct purchases and transactions directly from the pages of the catalog.

The present invention is also directed to jewelry boxes and similar products. Generally, jewelry boxes are little more than utilitarian containers. While there are music boxes, there are no gift boxes that have the ability to play video and audio that are uniquely associated with the ornamental object that is displayed therein. The present invention enables video and audio content to be incorporated into jewelry boxes for any variety of purposes, such as for marketing, personalized commemoration, or novelty.

### SUMMARY OF THE INVENTION

It is an object of the invention to enable video and audio content to be synchronized with the tactile experience associated with the opening of a page of a book or a lid of a box.

It is an object of the invention to provide a book, photo album, catalog, and jewelry box having multi-media content that can be updated.

A multi-media system for electronic presentation of video and audio content according to an embodiment of the present invention comprises a book having a front cover and a back cover bound together on one side, with at least one page, but preferably a plurality of pages, there between. The pages can be bound or removably attached. In an embodiment, the pages are provided with holes to fin any standard 3-ring binders (or variation thereof).

The book contains at least one sensor for determining when a particular page of the book is open. The sensor can be of any type known in the art, such as magnetic reed switches, or photocells, pressure transducers, or vibration sensors. For example, a reed switch is an electric switch operated by an applied magnetic field using magnets to detect the opening of a page. A photocell works by using light sensitive cells to determine if a page is open based on lighting conditions to detect the opening of a page. A pressure transducer converts pressure into an analog electrical signal to detect the opening of a page. In an alternative embodiment, the book contains a plurality of such sensors for determining the opening of the plurality of pages.

The sensors are located in correspondence with a plurality of magnets, each magnet being located at a different position on each of the plurality of pages, such that the location of the magnet is coded to the opening of the particular page. In this way, the opening of a particular page can be determined.

The book has a media device located between the covers for electronically playing video and audio content. The media device can have a means known in the art for removably attaching to the book, such that the media device can be attachable to any book having the elements of the present invention. In this way, the media device can be used interchangeably with any number of books having the elements of the present invention. The video and audio are activated upon the opening of the book by the sensor(s). The video and audio content of the media device can be changed and programmed by means of a connection to an external computer source, such as a local computer or a network of computers (e.g. Internet). The means for connecting to the external computer or other content source can be of any type known in the art.

In a preferred embodiment of the invention, each page of the book can be associated with unique video and audio content. The media device will play different content for different opened pages of the book. The content can be changed such that different content is played for the same page of the book on different viewings.

In another embodiment of the invention, a photo album has a plurality of removable pages for accommodating pictures therein. The pages can have holes for removably attaching to any standard 3-ring photo album (or variation thereof). The photo album contains at least one sensor for determining when a page is opened to a particular picture, but in a preferred embodiment a plurality of sensors are employed which correspond to the plurality of pages or pictures of the album. The photo album has a media device with a screen for electronically displaying visual content and an audio device for playing music or other sound effects. The video and audio are activated upon the opening of a page to a particular picture by the sensor(s). The media device is capable of being installed in any standard photo album as such by attachment means known in the art.

In a wedding photo album, for example, the media device can play wedding videos and music to accompany the pictures in the photo album. When a page is opened to a picture of the bride and groom cutting the wedding cake, for instance, the media device will play a video of the cutting ceremony, and so on.

The media device is not only capable of playing video and audio content, it is also capable of storing digital photo and music files. The media device has a means for connecting to a computer, or other media device, or the Internet for transferring (e.g. uploading and downloading) of new content files. In this way, thousands of extraneous digital photos that would otherwise take up multitudes of albums could be compactly stored and organized to correspond to the physical pictures in a single album.

In another embodiment of the invention, a sales catalog has sensors and a media device in a manner like the book and photo album described herein. The sensors can be specifically located in relation to certain goods featured in the catalog. The goods are associated with barcodes for identifying the goods. When the sensors determine that the featured goods are viewed on an opened page, the sensors activate specific video and audio content to enhance the promotional effects of the advertisement for the goods. Further, the media device can be provided with a touchscreen and a standard means for connecting to an external computing source or media device so that online purchasing can be transacted directly from the catalog using the barcodes.

A jewelry box according to an embodiment of the present invention has a pillow holder for holding an ornamental object in a case with a lid. The lid is hingedly connected to open and close over the case. The jewelry box has a sensor for detecting the opening and closing of the lid. A media device is mounted inside the lid, which is capable of playing video and audio content. When the lid is opened, the sensor activates the media device. The media device is deactivated when the lid is closed.

In another embodiment, the jewelry box has an additional sensor to detect if the ornamental object is removed from the pillow holder, which causes preprogrammed content to be played on the media device. In this way different content is associated with the opening of the jewelry box and with the removal of the ornamental object inside. For example, when the jewelry box is opened, music is played (e.g. swirling harp sounds), and when the ornamental object is removed from its pillow holder, a video message is played (e.g. a video message that says, “Go ahead and try it on . . . ” or “It looks beautiful on you . . . ”). The media device is also capable of connecting to the Internet by means known in the art so as to enable new content to be downloaded onto it.

### BRIEF DESCRIPTION OF THE DRAWINGS

FIG. 1A is a perspective view of a book embodiment of the invention.

FIG. 1B is a perspective view of another book embodiment of the invention.

FIG. 2 is a front view of pages having cut-out openings in a book embodiment of the invention and locations of sensors.

FIG. 3 is a perspective view of a photo album embodiment of the invention.

FIG. 4 is a perspective view of a catalog embodiment of the invention.

FIG. 5 is a perspective view of a jewelry box embodiment of the invention.

### DETAILED DESCRIPTION OF PREFERRED EMBODIMENTS

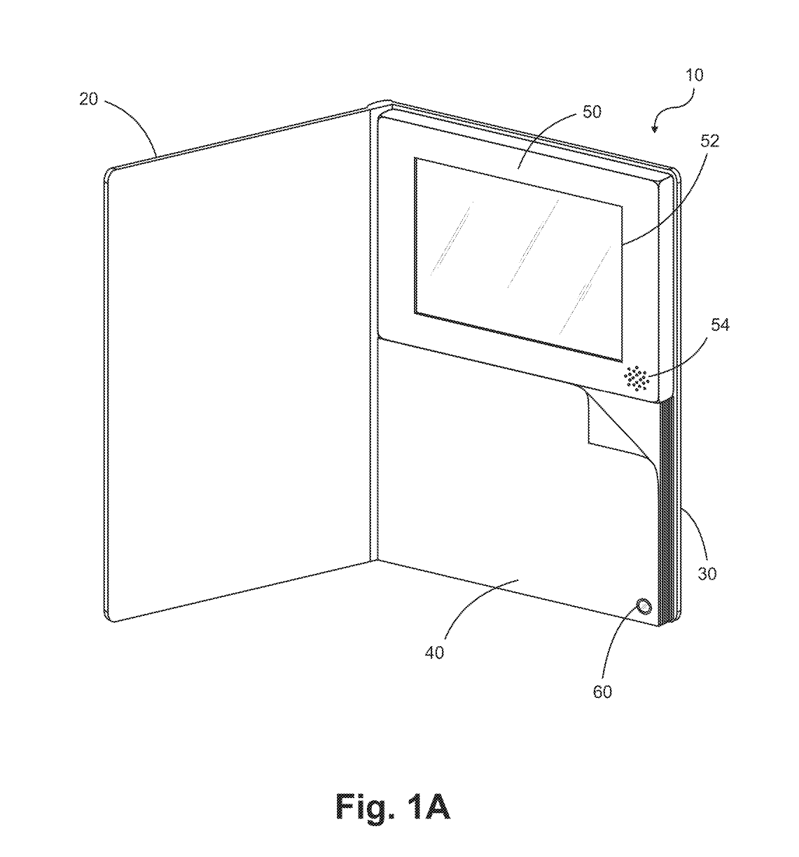

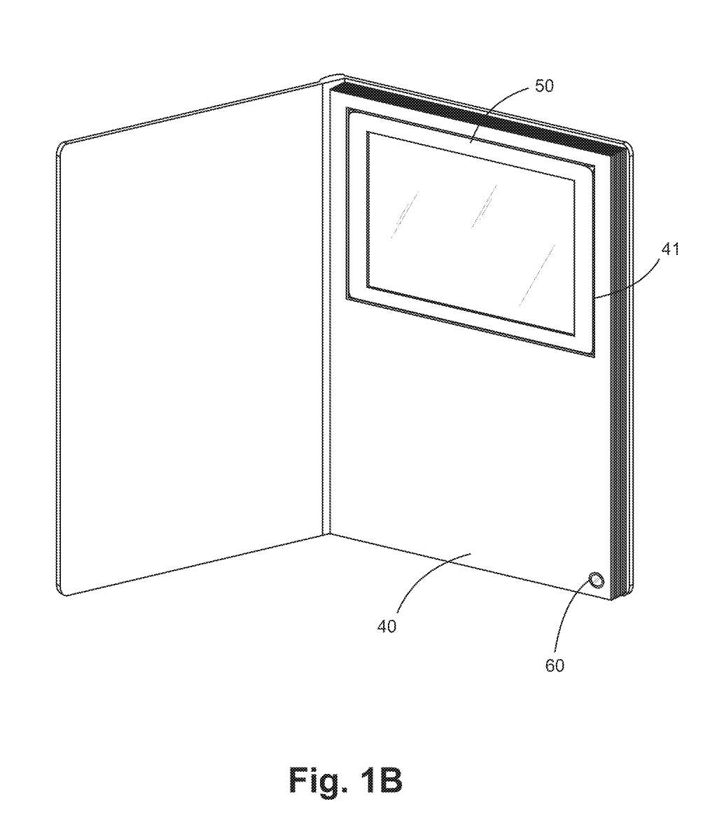

A book 10 in accordance with an embodiment of the present invention is shown in FIG. 1. The book 10 includes a front cover 20 and a back cover 30 bound on one side. While front cover 20 and back cover 30 are rectangular in shape as shown, the covers 20, 30 can be of any shape or size. Front cover 20 has an exterior side 22 and an interior side 24. Back cover 30 has an exterior side 32 and an interior side 34. Front cover 20 is bound, hingedly connected, or otherwise coupled to back cover 30 by means known in the art at spine 5. Covers 20, 30 are bound such that interior side 24 and interior side 34 face each other when book 10 is closed, a position in which front cover 20 substantially overlays back cover 30. By contrast, book 10 is opened when front cover 20 does not substantially overlay back cover 30.

A page 40 has a first side 42 and a second side 44. At least one page 40 is attached between front cover 20 and back cover 30 at spine 5. In a preferred embodiment, book 10 has a plurality of pages 40.

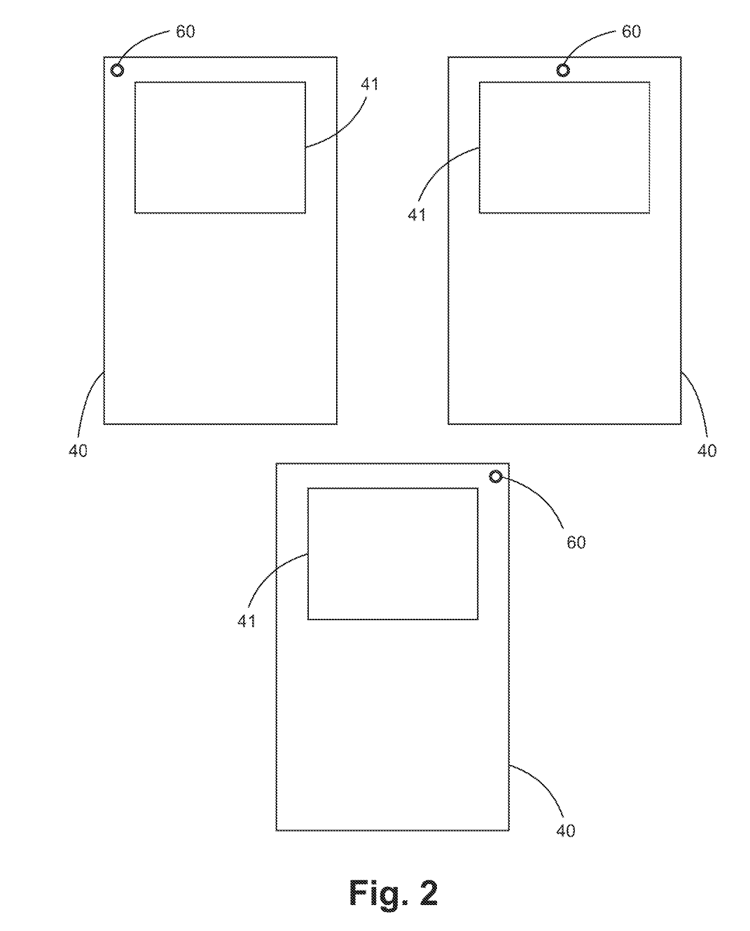

Book 10 contains a media device 50 capable of playing video and audio content. Media device 50 contains screen 52, which can be of any type known in the art (e.g. liquid crystal display), and audio player 54. In a preferred embodiment of the invention, media device 50 is removably mounted to interior side 34 of back cover 30 as shown in FIG. 2. Media device 50 is powered by a power source (not shown), such as batteries or an external power outlet.

In an embodiment, media device 50 is mounted adjacent to pages 40. As shown in FIG. 1A, pages 40 are bound below media device 50 so that pages 40 can be turned without blocking screen 52 or audio player 54.

In an alternative embodiment as shown in FIG. 1B, page 40s have cut-out openings 41 such that media device 50 can be viewed through cut-out openings 41 when book 10 is in an opened position.

Book 10 has at least one sensor 60. At least one sensor 60 is embedded in book 10 in a manner not readily visible for detecting the opening of front cover 20, back cover 30, or page 40. Sensor 60 can be of any kind known in the art, such as magnetic reed switches, or photocells, pressure transducers, or vibration sensors. The sensor 60 operates according to methods known in the art to determine the opening or closing of book 10.

In a preferred embodiment of the invention, a plurality of sensors 60 are embedded throughout book 10 to accurately determine the position of each page 40. Sensors 60 can be located at different positions on different pages 40 (and covers 20, 30) as shown in FIG. 2.

Each sensor 60 is capable of functioning to activate media device 50. When a page 40 is turned to an opened position, a sensor 60 detects that page 40 is being viewed, which operates to activate media device 50. Conversely, closing book 10 will automatically deactivate media device 50. Because sensors 60 can be located at different positions on different pages 40 and covers 20, 30, the media device 50 can be synchronized to play unique video and audio content corresponding to specific pages 40 or covers 20, 30.

In a preferred embodiment of the invention, the content on media device 50 will be specifically synchronized with book 10, such that the opening of front cover 20, or back cover 30, or any specific page 40 will cause unique content to be played on media device 50. In this way, different content will be played corresponding to different pages 40. Also, media device 50 is programmable to play different content on different viewings of the same page 40.

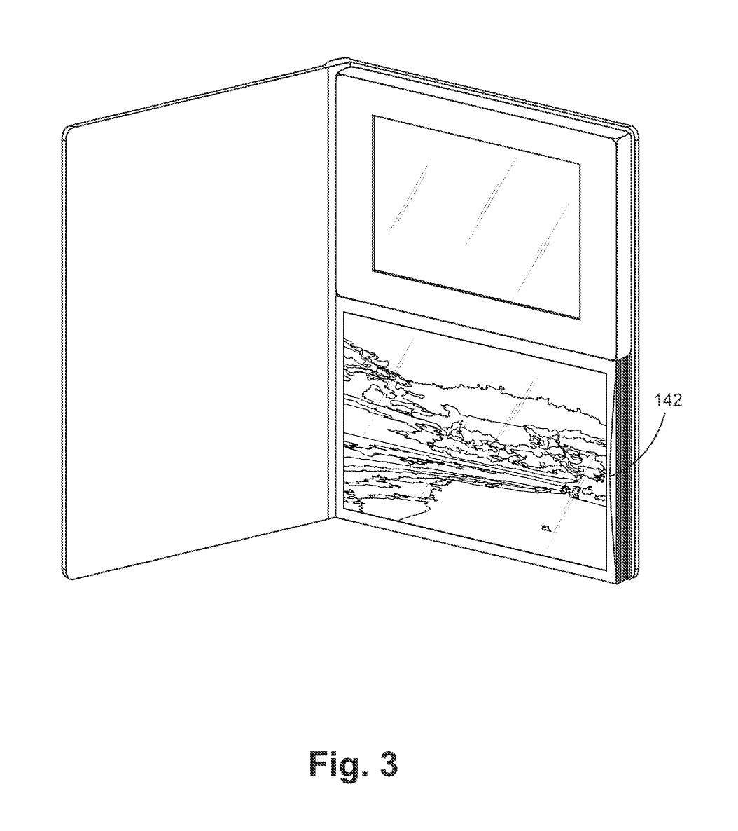

FIG. 3 shows photo album 110 in accordance with another embodiment of the present invention. Photo album 110 includes front cover 120, back cover 130, at least one page 140, media device 150, and sensor 160 assembled in a manner substantially like book 10. At least one page 140 has a pocket or sleeve 142 that is capable of accommodating pictures therein. Whereas in book 10 the media device 50 is synchronized with pages 40, in photo album 110 the media device 150 can be programmed to play content according to specific pictures contained in photo album 110.

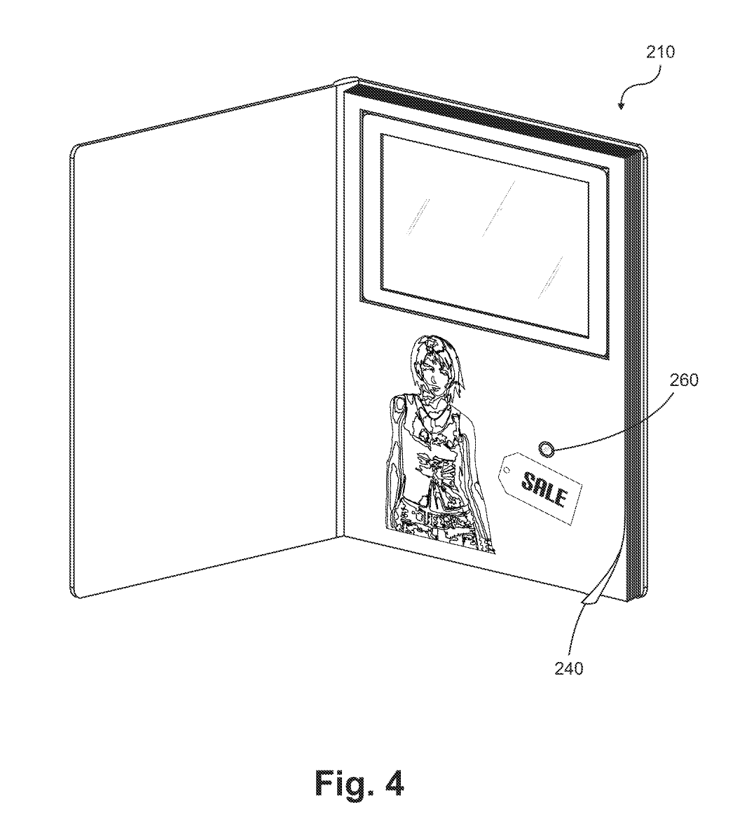

FIG. 4 shows catalog 210 in accordance with another embodiment of the present invention. Catalog 210 includes front cover 220, back cover 230, at least one page 240, media device 250, and sensor 260 assembled in a manner substantially like book 10. At least one page 240 contains advertising or marketing of a product or service thereon. Sensor 260 is associated with page 240. Media device 250 can be programmed to play content according to a specific product or service featured in catalog 210. Further, catalog 210 has a means for connecting to the Internet that can be used to purchase the advertised goods or services.

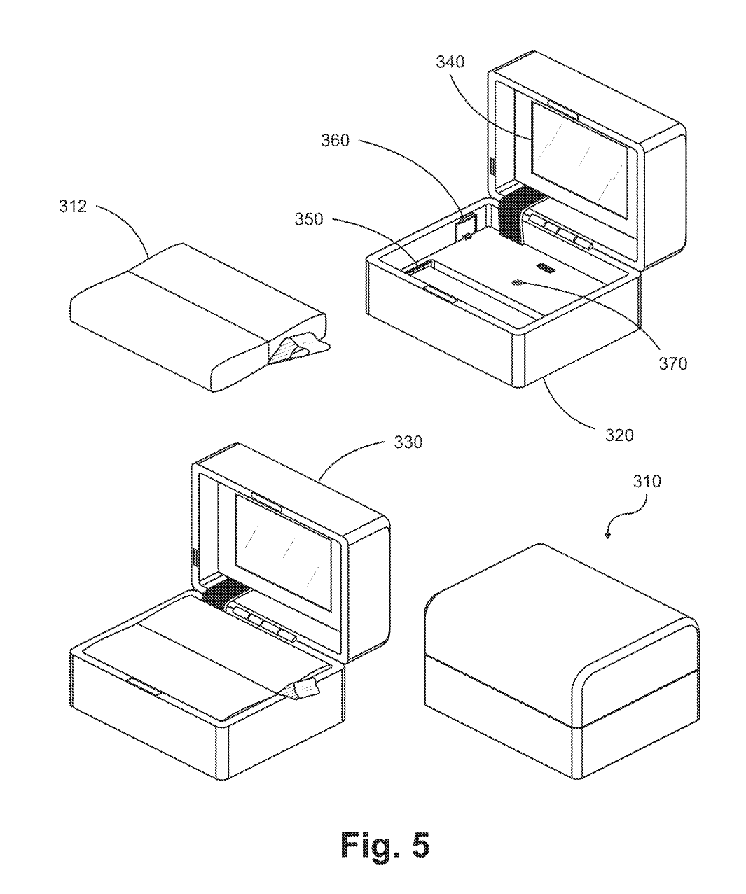

FIG. 5 shows jewelry box 310 in accordance with another embodiment of the present invention. Jewelry box 310 has a pillow 312 for holding an ornamental object (now shown) therein. Jewelry box 310 has a case 320 and a lid 330. Lid 330 is hingedly connected to case 320 such that lid 330 is capable of closing and opening in relation to case 320. A media device 340 is mounted on an inside surface of lid 330. Media device 340 is capable of playing video and audio content. A power source 350 supplies power to operate media device 340. A sensor 360 is mounted in relation to lid 330 for detecting the opening and closing of lid 330. Sensor 360 functions to activate media device 340 upon the opening of lid 330 and to deactivate media device 34 upon the closing of lid 330.

Jewelry box 310 has a connecting means 370 known in the art for communicating with the Internet, which enables content to be downloaded from the Internet onto media device 340.

1. A multi-media system for electronic presentation of video and audio, said system comprising:
a first cover, said first cover having a plurality of sides;
a second cover, said second cover connected to said first cover on one said side, such that said second cover is capable of opening and closing in relation to said first cover;
at least one page removably connected between said first cover and said second cover;
a sensor for determining whether said page is open;
a media device, located between said first cover and said second cover, having a screen for electronically displaying visual content and an audio device for playing audio content;
wherein said media device is activated upon the opening of said page by said sensor.

2. The system according to claim 1, wherein said system comprises a plurality of pages assembled between said first cover and said second cover.

3. The system according to claim 2, said system further comprising a plurality of sensors, wherein a first sensor determines the opening of said first cover, a second sensor determines the opening of said second cover, and the opening of each of said plurality of pages is determined by a separate sensor.

4. The system according to claim 3, wherein said video and audio content played on said media device is capable of changing in correlation with the opening of said first cover, said second cover, and each said page.

5. The system according to claim 1, wherein said system constitutes a photographic album with said at least one page being capable of accommodating a picture therein.

6. The system according to claim 1, wherein said system constitutes a catalog for the promotion of goods with said at least one page featuring said goods and said media device displays video and audio content in relation to said goods.

7. The system according to claim 1, wherein said screen is a touchscreen that can detect the presence and location of a touch within a display area.

8. The system according to claim 1 and claim 7, wherein said system has a means for connecting to a computer or an Internet for changing video and audio content.

9. The system according to claim 8, wherein said media device can be used to conduct transactions via an external communication link.

10. The system according to claim 1, wherein said sensor is comprised of a magnetic reed switch for detecting the opening of said page in said system.

11. The system according to claim 1, wherein said sensor is comprised of a photocell switch for detecting the opening of said page in said system.

12. The system according to claim 1, wherein said sensor is comprised of a pressure transducer that converts pressure into an analog electrical signal to detect the opening of said page in said system.

13. A jewelry box for holding an ornamental object therein, said box comprising:
a case;
a lid hingedly connected to said case, said lid capable of closing and opening in relation to said case;
a media device mounted on an inside surface of said lid, said media device capable of playing video and audio content;
a switch mounted in relation to said lid, such that said switch functions to activate said media device upon the opening of said lid and to deactivate said media device upon the closing of said lid.

14. The jewelry box according to claim 13 having a power source for supplying power to operate said media device, said power source located in said case.

15. The jewelry box according to claim 13 having a connecting means for communicating with an Internet, wherein said jewelry box is capable of downloading content from said Internet to said media device.

17. The jewelry box according to claim 13 further comprising a removable pillow for holding said ornamental object, said pillow located in said case.
